(19) United States
(12) Patent Application Publication
(10) Pub. No.: US 2002/0144409 A1
(43) Pub. Date: Oct. 10, 2002

(54) Versatile survival knife

(76) Inventor: Chien-Rung Chen, Taipei City (TW)

Correspondence Address: Chien-Rung CHEN, PO Box 82-144, TAIPEI, TW

(21) Appl. No.: 09/824,680

(22) Filed: Apr. 4, 2001

(51) Int. Cl. B26B 1/00

(52) U.S. Cl. 30/299; 30/122; 30/329

(57) ABSTRACT

A versatile survival knife includes a blade and a handle into which the blade is detachably inserted. The blade is provided at one end with a pointed tip and at the other end a flat tip. When the blade is inserted into the handle at the end with the pointed tip, the survival knife appears in the form of a flat-tipped knife, and when the blade is inserted into the handle at the end with the flat tip, the survival knife appears in the form of a pointed-tipped knife. The blade is also provided on its body with a line of length-adjusting holes. By inserting the blade into the handle with one of the length-adjusting holes aligned with a fixing hole on the handle, a length of the blade exposed from the handle can be changed into longer or shorter to meet actual need. Thus, up to four different forms are available from only one single survival knife to conveniently perform different functions.

### FIELD OF THE INVENTION

The present invention relates to a versatile survival knife, and more particularly to a survival knife, a blade of which having a pointed tip and a flat tip at two ends thereof and a plurality of length-adjusting holes formed on a body thereof, so that the same one survival knife may appear in up to four different forms, namely, long-blade and short-blade pointed-tipped survival knives as well as long-blade and short-blade flat-tipped survival knives.

### BACKGROUND OF THE INVENTION

A survival knife is a useful item for mountain climbers and divers to survive an emergency in climbing and diving. There are different types of survival knives designed to meet users' different needs and requirements. Conventional survival knives can be generally divided into long-blade survival knife 10 and short-blade survival knife 20, as shown in FIGS. 1A-1C and FIGS. 1B-1D, respectively. The long-blade survival knife 10 is usually used in mountain climbing to chop off branches of trees and other obstructions on the road. It could also be conveniently used to cut thick things, fruits, etc. However, it is not conveniently portable and occupies large space due to its large size. On the other hand, the short-blade survival knife 20 is not suitable for cutting large and thick things but can be conveniently stored and carried. Alternatively, the conventional survival knives can also be divided into pointed-tipped survival knife 30 and flat-tipped survival knife 40, as shown in FIGS. 1A, 1B and FIGS. 1C, 1D, respectively. The pointed-tipped survival knife 30 is usually used to cut food by piercing its pointed tip into food before cutting the food, while the flat-tipped survival knife 40 is usually used to dig the ground, crush stone, dig out wild vegetables, dig clams and scallops out of rocks, etc.

In brief, the survival knives appear in at least four different forms, namely, long-blade, short-blade, pointed-tipped, and flat-tipped survival knives. Generally, consumers would select and purchase one of these four types of survival knives based on their budgets and actual needs. However, one single type of survival knife could not satisfy different needs of the consumer's in outdoor activities. And, purchasing all four types of survival knives would cost the consumers a lot of money and it is inconvenient to carry all four types of survival knives at the same time.

Moreover, all the conventional survival knives include a tang 60 that is formed by blunting two sides of a rear portion of the blade for inserting into a handle 50 of the knife and does not have any other function. Thus, material for the tang 60 and labors and time for shaping and blunting the same simply increase the cost of the conventional survival knives.

### SUMMARY OF THE INVENTION

A primary object of the present invention is to provide a versatile survival knife from which up to four different forms are available to perform different functions at different conditions, so that a consumer needs only buy one versatile survival knife at less cost instead of purchasing and carrying four different types of conventional survival knives at the same time.

To achieve the above and other objects, the versatile survival knife of the present invention mainly includes a blade and a handle into which the blade is detachably inserted. The blade is provided at one end with a pointed tip and at the other end a flat tip. When the blade is inserted into the handle at the end with the pointed tip, the survival knife appears in the form of a flat-tipped knife, and when the blade is inserted into the handle at the end with the flat tip, the survival knife appears in the form of a pointed-tipped knife. The blade is also provided on its body with a line of spaced length-adjusting holes. By inserting the blade into the handle with one of the length-adjusting holes aligned with a fixing hole on the handle, a length of the blade exposed from the handle can be changed into longer or shorter to meet actual need. Thus, up to four different forms are available from only one single survival knife to conveniently perform different functions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 illustrates different types of conventional survival knives and the manner of connecting a blade to a handle of the conventional survival knife;

FIG. 2 is an exploded perspective of a survival knife according to a first embodiment of the present invention;

FIG. 3 is a fragmentary assembled sectional view showing the connection of a blade to a handle of the survival knife of FIG. 2;

FIG. 4 shows the survival knife of FIG. 2 is adjusted into a long-blade pointed-tipped survival knife;

FIG. 5 shows the survival knife of FIG. 2 is adjusted into a short-blade flat-tipped survival knife;

FIG. 6 shows a second embodiment of the present invention that can be adjusted into a pointed-tipped and a flat-tipped survival knife;

FIG. 7 shows a third embodiment of the present invention that can be adjusted into a long-blade and a short-blade pointed-tipped survival knife; and

FIG. 8 shows a fourth embodiment of the present invention that can be adjusted into a long-blade and a short-blade flat-tipped survival knife.

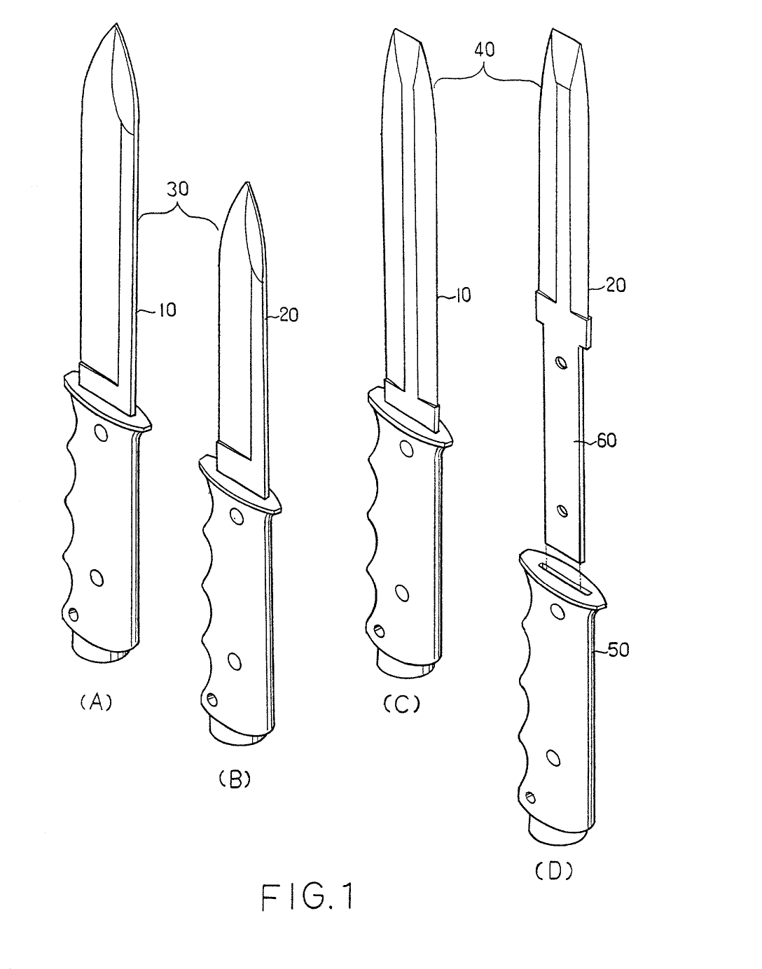

### DETAILED DESCRIPTION OF THE PREFERRED EMBODIMENTS

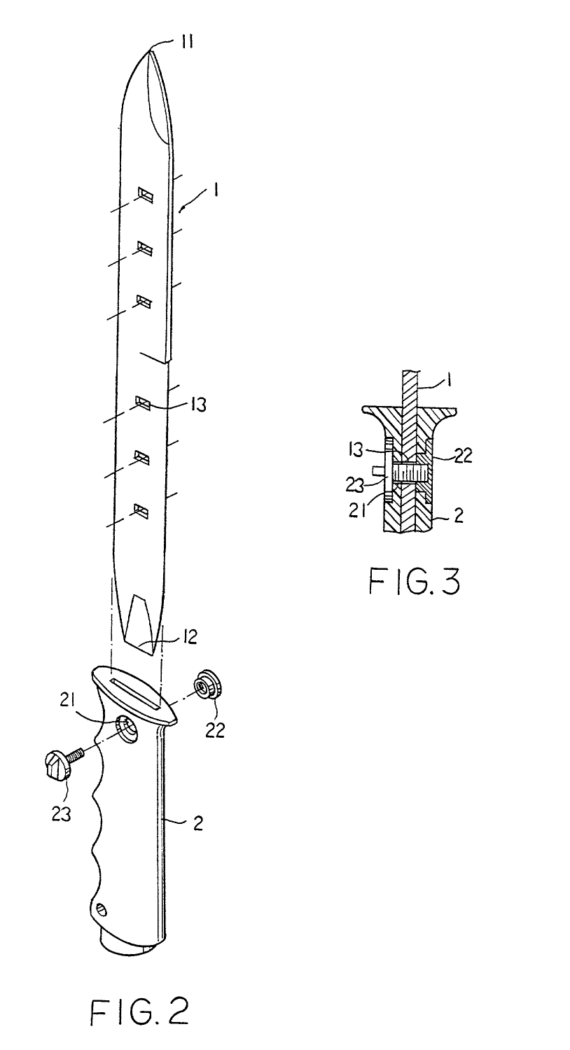

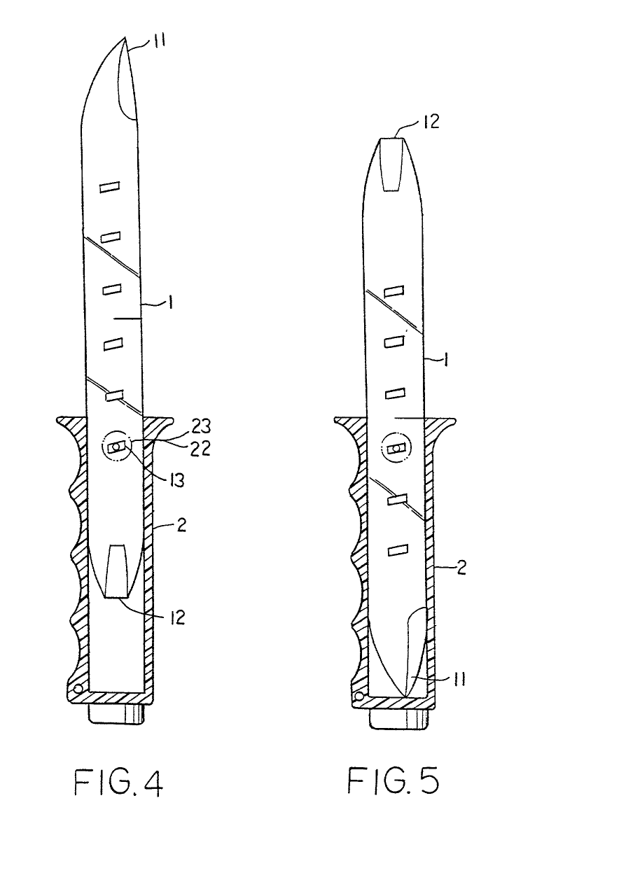

Please refer to FIG. 2 that is an exploded perspective of a versatile survival knife according to a first embodiment of the present invention. As shown, the versatile survival knife of FIG. 2 mainly includes a blade 1 and a handle 2 into which one end of the blade 1 is detachably inserted. A first end of the blade 1 is formed into a pointed tip 11 and a second end opposite to the first end is formed into a flat tip 12. The blade 1 is provided on its body with a plurality of linearly spaced length-adjusting holes 13. The handle 2 is provided at a predetermined position with a fixing hole 21 with a nut 22 embedded in the fixing hole 21 at one side of the handle 2. After the blade 1 is inserted into the handle at either the first or the second end of the blade 1, it is fixed to the handle 2 by extending a hand-turnable bolt 23 through the fixing hole 21 and one of the length-adjusting holes 13 to engage with the embedded nut 22, as shown in FIG. 3. When the blade 1 is inserted into the handle 2 at the second end, that is, the flat tip 12, so that the first end, that is, the pointed tip 11, is exposed to outside, as shown in FIG. 4, a pointed-tipped survival knife is provided. Or, when the blade1 is inserted into the handle 2 at the first end, that is, the pointed tip 11, so that the second end, that is, the flat tip 12, is exposed to outside, as shown in FIG. 5, a flattipped survival knife is provided. The survival knife according to the first embodiment of the present invention, either in the form of a pointed-tipped or a flat-tipped survival knife, may be adjusted for the blade to expose from the handle 2 by different length simply by selecting a desired length-adjusting hole 13 and aligning it with the fixing hole 21 on the handle 2 before engaging the hand-turnable bolt 23 with the nut 22. Therefore, the same one survival knife according to the first embodiment of the present invention can be freely converted into long-blade pointed-tipped, short-blade pointed-tipped, longblade flat-tipped or short-blade flat-tipped survival knife as desired to perform different functions.

The length-adjusting holes 13 on the blade 1 are through holes being sized for a user to easily hold the blade 1 at any of the hole 13 with two fingers without the risk of a slipped blade 1. Thus, the length-adjusting hole 13 enables the user to securely remove and replace the blade 1 from and into the handle 2 even under water to complete the conversion of the survival knife from one form to another.

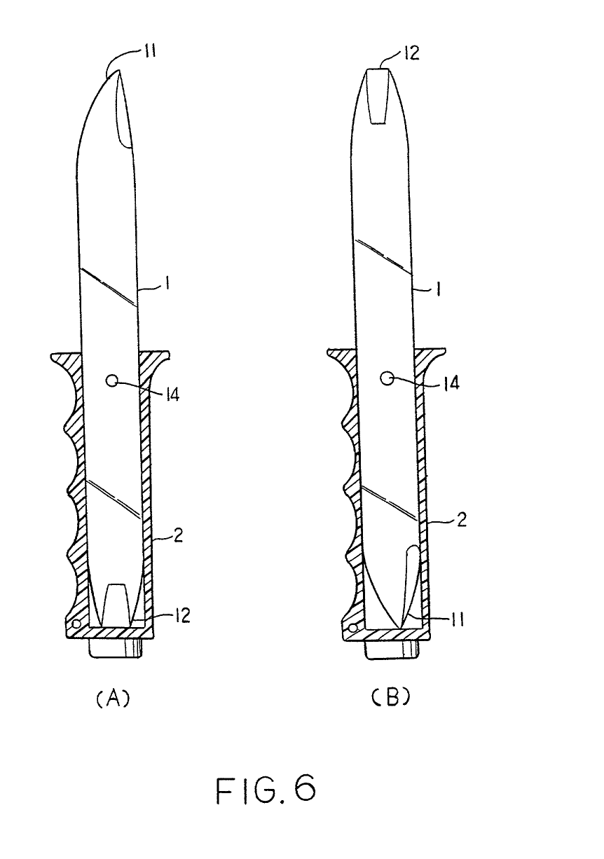

In a survival knife according to a second embodiment of the present invention as shown in FIG. 6, there is only one common fixing hole 14 provided on the blade 1. The blade 1 in this second embodiment also includes a pointed-tipped end 11 and a flat-tipped end 12. The blade 1 may be inserted into the handle 2 either at the pointed-tipped or the flat-tipped end and fixed thereto by extending the hand-turnable screw (not shown in FIG. 6) through the common fixing hole 14 to engage with the embedded nut (not shown in FIG. 6). In this case, the resultant pointed-tipped and flat-tipped survival knives, as shown in FIGS. 6A and 6B, respectively, have fixed length of blade exposed from the handle 2.

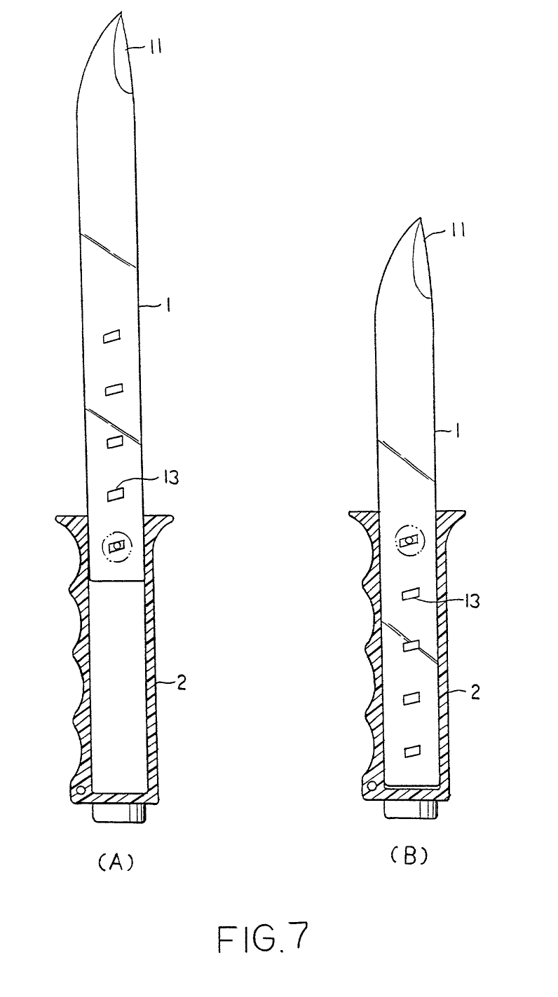

FIG. 7 shows a survival knife according to a third embodiment of the present invention. In this embodiment, the blade 1 is provided at one end with a pointed tip 11. Another end of the blade 1 opposite to the pointed tip 11 is only a blunt bottom. The blade 1 is provided on its body with a plurality of linearly spaced length-adjusting holes 13. By selecting a desired length-adjusting hole 13, it is possible to adjust a length of the blade 1 to be exposed from the handle 2. Thus, the survival knife according to the third embodiment of the present invention may appear in two forms, namely, long-blade and short-blade pointed-tipped survival knives, as shown in FIGS. 7A and 7B, respectively.

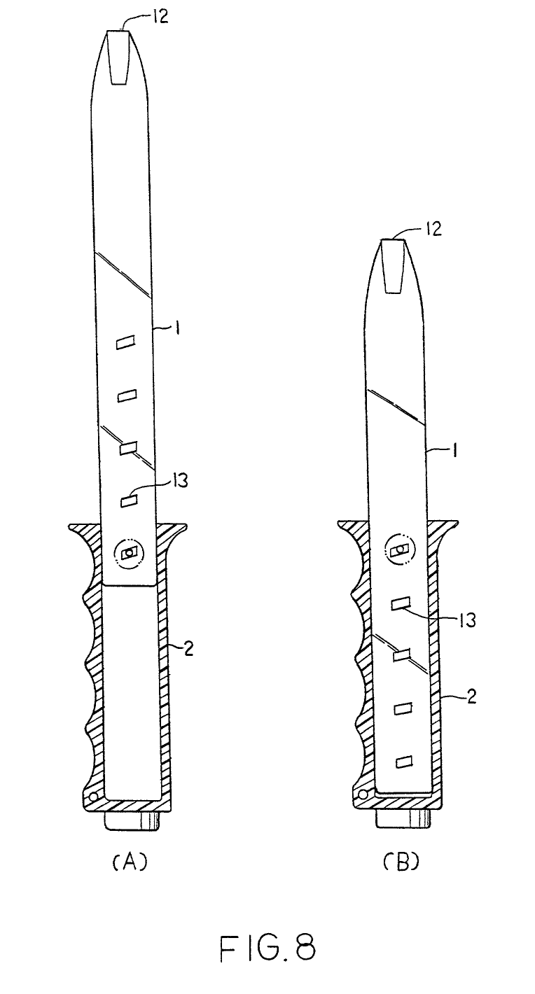

FIG. 8 shows a survival knife according to a fourth embodiment of the present invention. In this embodiment, the blade 1 is provided at one end with a flat tip 12. Another end of the blade 1 opposite to the flat tip 12 is only a blunt bottom. The blade 1 is provided on its body with a plurality of linearly spaced length-adjusting holes 13. By selecting a desired length-adjusting hole 13, it is possible to adjust a length of the blade 1 to be exposed from the handle 2. Thus, the survival knife according to the fourth embodiment of the present invention may appear in two forms, namely, long-blade and short-blade flat-tipped survival knives, as shown in FIGS. 8A and 8B, respectively.

In brief, the present invention provides a versatile survival knife by forming at one or two ends of a blade with pointed and/or flat tips and on a body of the blade with one or more length-adjusting holes to change the length of the blade to extend from a handle of the knife, so that up to four different forms are available from only one single survival knife of the present invention to perform different functions in outdoor activities. Such versatile survival knife has novel structure and is convenient for carry and use, and is therefore superior to the conventional survival knives.

What is claimed is:

1. A versatile survival knife, comprising a blade and a handle into which said blade is detachably inserted; said survival knife being characterized in that said blade is formed at a first end with a pointed tip and at a second end opposite to the first end with a flat tip, whereby when said blade is inserted into said handle at said first end with said pointed tip, said survival knife appears in the form of a flat-tipped survival knife; and when said blade is inserted into said handle at said second end with said flat tip, said survival knife appears in the form of a pointed-tipped survival knife.

2. The versatile survival knife as claimed in claim 1, wherein said blade is provided on a body thereof with a plurality of linearly spaced length-adjusting holes, and a length of said blade to be exposed from said handle being adjustable by inserting said blade into said handle with one of said length-adjusting holes selected to align with a fixing hole provided on said handle.

3. A versatile survival knife, comprising a blade and a handle into which said blade is detachably inserted; said survival knife being characterized in that said blade is provided on a body thereof with a plurality of linearly spaced length-adjusting holes, and a length of said blade to be exposed from said handle being adjustable by inserting said blade into said handle with one of said length-adjusting holes selected to align with a fixing hole provided on said handle.

4. The versatile survival knife as claimed in claim 3, wherein said blade is provided at one end with a pointed tip.

5. The versatile survival knife as claimed in claim 3, wherein said blade is provided at one end with a flat tip.
